(19) United States
(12) Patent Application Publication
(10) Pub. No.: US 2018/0063725 A1
(43) Pub. Date: Mar. 1, 2018

(54) MU-MIMO GROUPING FOR A PLURALITY OF MU-MIMO CLIENTS

(71) Applicant: QUALCOMM Incorporated, San Diego, CA (US)

(72) Inventors: Ahmed Ragab Elsherif, San Jose, CA (US); Srinivasan Katar, Fremont, CA (US)

(21) Appl. No.: 15/249,241

(22) Filed: Aug. 26, 2016

(51) Int. Cl. H04W 24/02; H04B 7/04; H04W 4/08; H04L 1/00; H04W 24/10; H04L 5/00

(52) U.S. Cl. CPC H04W 24/02; H04B 7/0452; H04L 5/006; H04L 1/0009; H04W 24/10; H04W 4/08

(57) ABSTRACT

Methods, systems, and devices for wireless communication are described for multiple-user (MU) multiple-input multiple-output (MIMO) grouping for large numbers of MU-MIMO clients. In one example, a method for wireless communication includes identifying, from a compressed beamforming (CBF) report, a noise parameter for communications with a user equipment (UE). The method may also include determining at least one of an initial MU-MIMO group size and an initial modulation and coding scheme (MCS) based at least in part on the noise parameter. The method may also include transmitting data based on at least one of the initial MU-MIMO group size and the initial MCS.

### BACKGROUND

### Field of the Disclosure

The present disclosure, for example, relates to wireless communication systems, and more particularly to multiple-user (MU) multiple-input multiple-output (MIMO) grouping for a plurality of transit chains.

### Description of Related Art

Wireless communications systems are widely deployed to provide various types of communication content such as voice, video, packet data, messaging, broadcast, and so on. These systems may be multiple-access systems capable of supporting communication with multiple users by sharing the available system resources (e.g., time, frequency, and power). A wireless network, for example a wireless local area network (WLAN), such as a Wi-Fi (i.e., Institute of Electrical and Electronics Engineers (IEEE) 802.11) network may include an access point (AP) that may communicate with at least one station (STA) or mobile device. The AP may be coupled to a network, such as the Internet, and may enable a mobile device to communicate via the network (or communicate with other devices coupled to the access point). A wireless device may communicate with a network device bi-directionally. For example, in a WLAN, a STA may communicate with an associated AP via downlink (DL) and uplink (UL). The DL (or forward link) may refer to the communication link from the AP to the station, and the UL (or reverse link) may refer to the communication link from the station to the AP.

A total network capacity for a WLAN in a MU-MIMO group may be based on the size of the MU-MIMO group. The capacity of the network may diminish with larger group size. For example, for larger group sizes, the capacity of the network may be less and a modulation and coding scheme (MCS) and data rate may be lower than for smaller group sizes.

### SUMMARY

The described techniques relate to improved methods, systems, devices, or apparatuses that support MU-MIMO grouping for a large number of MU-MIMO clients. Generally, the described techniques provide for selecting an initial MU-MIMO group size and an initial MCS for a MU-MIMO group. The selection of the initial MU-MIMO group size and the initial MCS may be based at least in part on at least one compressed beamforming report from a STA in the MU-MIMO group or a STA that desires to be in the MU-MIMO group.

In a first set of illustrative examples, a method for wireless communication is described. In one configuration, the method includes identifying, from a compressed beamforming (CBF) report, a noise parameter for communications with a user equipment (UE). The method also includes determining at least one of an initial MU-MIMO group size and an initial MCS based at least in part on the noise parameter. The method may also include transmitting data based on at least one of the initial MU-MIMO group size and the initial MCS.

In a second set of illustrative examples, an apparatus for wireless communication is described. The apparatus may include a processor and memory in electronic communication with the processor. The apparatus may further include instructions stored in the memory and operable, when executed by the processor, to cause the apparatus to identify, from a CBF report, a noise parameter for communications with a UE. The apparatus may further include instructions stored in the memory and operable, when executed by the processor, to cause the apparatus to determine at least one of an initial MU-MIMO group size and an initial MCS based at least in part on the noise parameter. The apparatus may further include instructions stored in the memory and operable, when executed by the processor, to cause the apparatus to transmit data based on at least one of the initial MU-MIMO group size and the initial MCS.

In a third set of illustrative examples, an apparatus for wireless communication is described. The apparatus may include means for identifying, from a CBF report, a noise parameter for communications with a UE and means for determining at least one of an initial MU-MIMO group size and an initial MCS based at least in part on the noise parameter. The apparatus may also include means for transmitting data based on at least one of the initial MU-MIMO group size and the initial MCS.

In a fourth set of illustrative examples, a non-transitory computer readable medium storing code for wireless communication is described. The code may comprise instructions executable by a processor to identify, from a CBF report, a noise parameter for communications with a UE, determine at least one of an initial MU-MIMO group size and an initial MCS based at least in part on the noise parameter, and transmit data based on at least one of the initial MU-MIMO group size and the initial MCS.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purpose of illustration and description only, and not as a definition of the limits of the claims.

### BRIEF DESCRIPTION OF THE DRAWINGS

A further understanding of the nature and advantages of the present disclosure may be realized by reference to the following drawings. In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1 illustrates an example of a system for wireless communication that supports MU-MIMO grouping for a large number of MU-MIMO clients in accordance with aspects of the present disclosure.

FIG. 2 illustrates an example of a graph illustrating an example sum capacity over group size and an example selection of an initial MU-MIMO group size.

FIG. 3 illustrates an example of a swim diagram that shows an AP connected to multiple STAs that supports MU-MIMO grouping for a large number of MU-MIMO clients in accordance with aspects of the present disclosure.

FIGS. 4 through 6 show block diagrams of a device that supports MU-MIMO grouping for a large number of MU-MIMO clients in accordance with aspects of the present disclosure.

FIG. 7 illustrates a block diagram of a system including a wireless device that supports MU-MIMO grouping for a large number of MU-MIMO clients in accordance with aspects of the present disclosure.

FIGS. 8 through 12 illustrate methods for MU-MIMO grouping for a large number of MU-MIMO clients in accordance with aspects of the present disclosure.

### DETAILED DESCRIPTION

In some WLAN standards (e.g., 802.11ax), 8×8 APs can support up to eight STAs (also referred to herein as users) using MIMO techniques. As the MU-MIMO group size changes, the capacity of the network may change for any given signal-to-noise ratio (SNR) and channel. The capacity of the network may peak, in some examples, with some number of the allowed total users. Selecting the MU-MIMO group size for the MIMO network based on the capacity of the network may be beneficial to the performance of the network. Individual user experience may improve with improved network capacity. With larger numbers of STAs, the MCS may also be selected based on the MU-MIMO group size.

A preferred MU-MIMO group size may be based on an average single-user (SU) SNR. For example, lower average SU SNRs may be able to support smaller group sizes. Further, the MU-MIMO group size may also be a function of channel type and correlation among the multiple users. For example, different channels can have different preferred group sizes at a specific SU SNR. A fixed group size (for example, 6 users) may not be optimal for all channel types. In some examples, the MU-MIMO group size may be dynamically changed throughout communications.

The techniques described herein may improve network performance in dense user environments. These techniques may provide more users with a consistent and reliable stream of data (e.g., average throughput) in the presence of many other users.

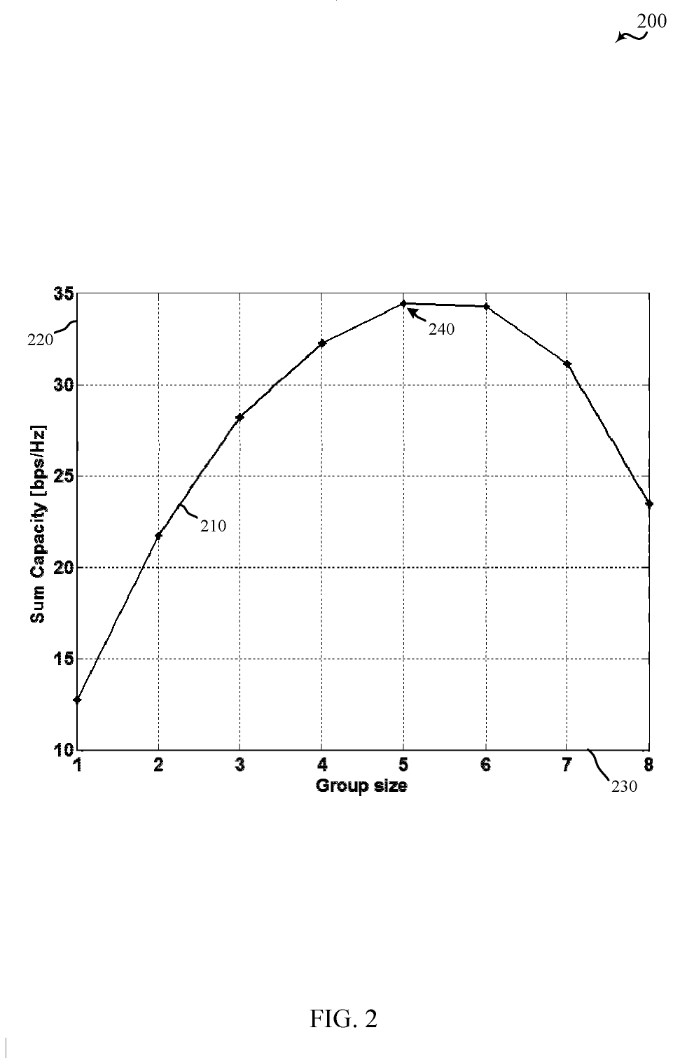

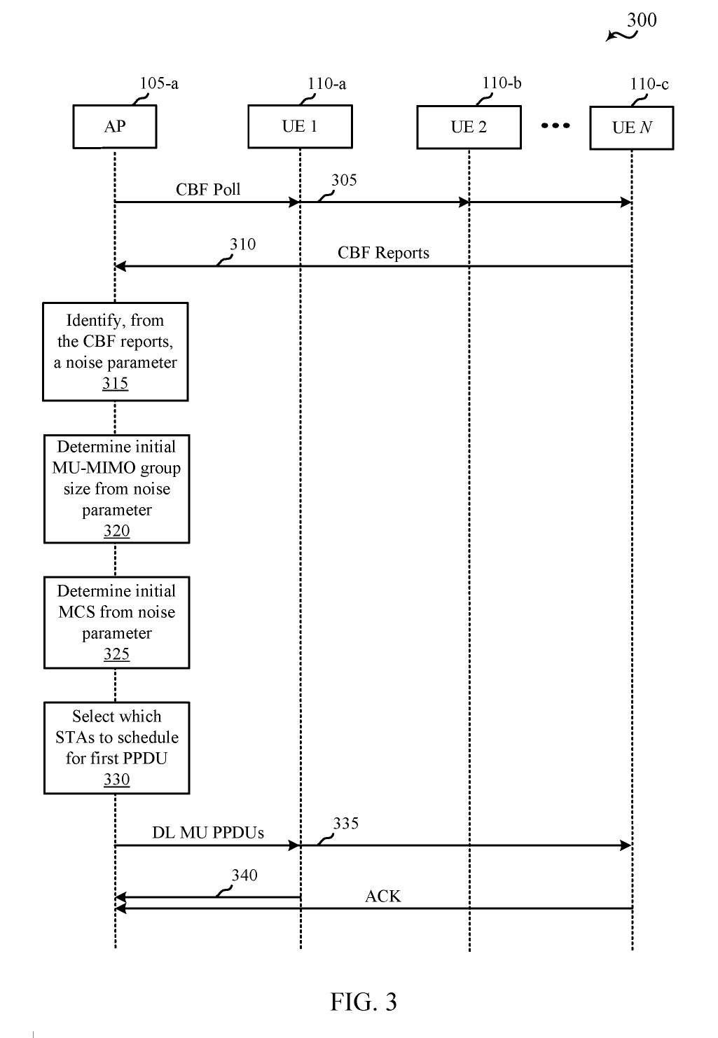

Aspects of the disclosure are initially described in the context of a wireless communications system. An example graph in FIG. 2 shows network capacity over group size. Processing of compressed beamforming (CBF) reports and determining initial MU-MIMO group size and initial MCS is shown in the context of a swim diagram in FIG. 3. Aspects of the disclosure are further illustrated by and described with reference to apparatus diagrams, system diagrams, and flowcharts that relate to MU-MIMO grouping for a large number of MU-MIMO clients.

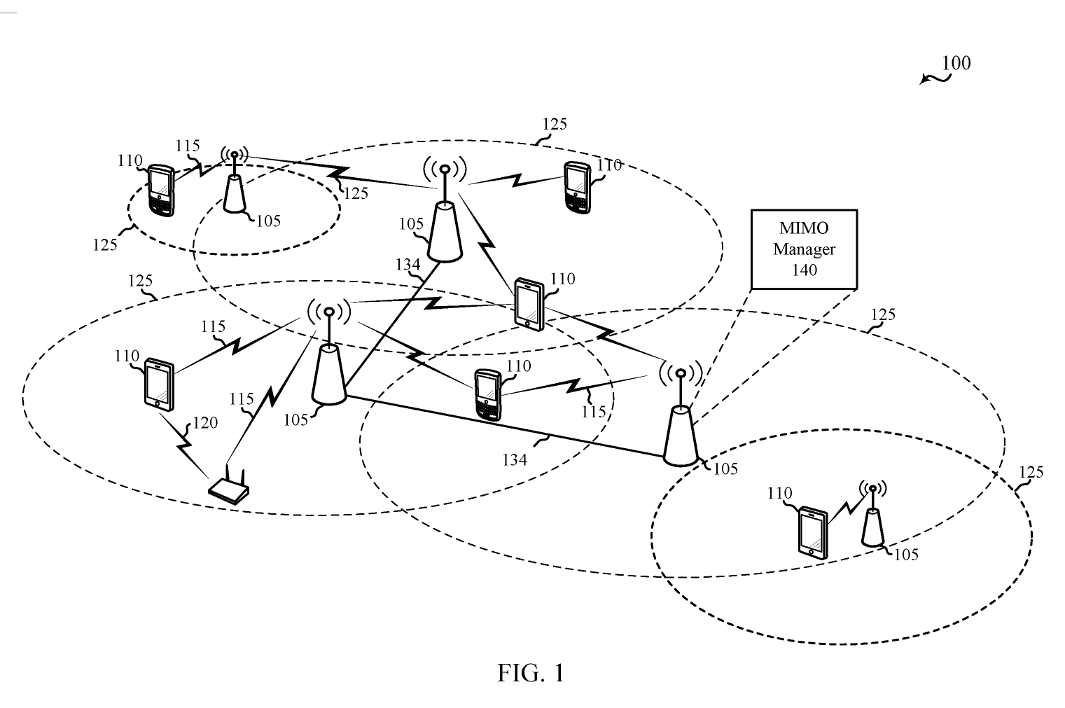

FIG. 1 illustrates a wireless local area network (WLAN) 100 (also known as a Wi-Fi network) configured in accordance with various aspects of the present disclosure. The WLAN 100 may include an AP 105 and multiple associated STAs 110, which may represent devices such as mobile stations, personal digital assistant (PDAs), other handheld devices, netbooks, notebook computers, tablet computers, laptops, display devices (e.g., TVs, computer monitors, etc.), printers, etc. The AP 105 and the associated stations 115 may represent a basic service set (BSS) or an extended service set (ESS). The various STAs 110 in the network are able to communicate with one another through the AP 105. Also shown is a coverage area 125 of the AP 105, which may represent a basic service area (BSA) of the WLAN 100. An extended network station associated with the WLAN 100 may be connected to a wired or wireless distribution system that may allow multiple APs 105 to be connected in an ESS.

A STA 110 may be located in the intersection of more than one coverage area 125 and may associate with more than one AP 105. A single AP 105 and an associated set of STAs 110 may be referred to as a BSS. An ESS is a set of connected BSSs. A distribution system may be used to connect APs 105 in an ESS. In some cases, the coverage area 125 of an AP 105 may be divided into sectors. The WLAN 100 may include APs 105 of different types (e.g., metropolitan area, home network, etc.), with varying and overlapping coverage areas 125. Two STAs 110 may also communicate directly via a direct wireless link 120 regardless of whether both STAs 110 are in the same coverage area 125. Examples of direct wireless links 120 may include Wi-Fi Direct connections, Wi-Fi Tunneled Direct Link Setup (TDLS) links, and other group connections. STAs 110 and APs 105 may communicate according to the WLAN radio and baseband protocol for physical and MAC layers from IEEE 802.11 and versions including, but not limited to, 802.11b, 802.11g, 802.11a, 802.11n, 802.11ac, 802.11ad, 802.11ah, 802.11ax, etc. In other implementations, peer-to-peer connections or ad hoc networks may be implemented within WLAN 100.

A STA 110 may be configured to collaboratively communicate with multiple APs 105 through, for example, MIMO, Coordinated Multi-Point (CoMP), or other schemes. MIMO techniques use multiple antennas on the base stations or multiple antennas on the STA 115 to take advantage of multipath environments to transmit multiple data streams. CoMP includes techniques for dynamic coordination of transmission and reception by a number of APs to improve overall transmission quality for STAs 110 as well as increasing network and spectrum utilization.

Modulation is the process of representing a digital signal by modifying the properties of a periodic waveform (e.g., frequency, amplitude and phase). Demodulation takes a modified waveform and generates a digital signal. A modulated waveform may be divided into time units known as symbols. Each symbol may be modulated separately. In a wireless communication system that uses narrow frequency subcarriers to transmit distinct symbols, the modulation is accomplished by varying the phase and amplitude of each symbol. For example, a binary phase-shift keying (BPSK) modulation scheme conveys information by alternating between waveforms that are transmitted with no phase offset or with a 180° offset (i.e., each symbol conveys a single bit of information). In a quadrature amplitude modulation (QAM) scheme, two carrier signals (known as the in-phase component, I, and the quadrature component, Q) may be transmitted with a phase offset of 90°, and each signal may be transmitted with specific amplitude selected from a finite set. The number of amplitude bins determines the number of bits that are conveyed by each symbol. For example, in a 16 QAM scheme, each carrier signal may have one of four amplitudes (e.g., −3, −1, 1, 3), which results in 16 possible combinations (i.e., 4 bits). The various possible combinations may be represented in a graph known as a constellation map, where the amplitude of the I component is represented on the horizontal axis and the Q component is represented on the vertical axis.

An AP 105 may include a MIMO manager 140. The MIMO manager 140 may perform some or all of the techniques described herein. The AP 105 may receive compressed beamforming (CBF) reports from STAs 110 connected to the AP 105. The MIMO manager 140 may identify, from the CBF report, a noise parameter for communication with the STA or user equipment (UE). The MIMO manager 140 may determine at least one of an initial MU-MIMO group size and an initial modulation and coding scheme (MCS) based at least in part on the noise parameter. The AP 105 may transmit data based on at least one of the initial MU-MIMO group size and the initial MCS. In some examples, a STA 110 may include a station MIMO manager that performs at least some of the techniques described herein.

FIG. 2 illustrates an example of a graph 200 illustrating an example sum capacity 220 over group size 230 and an example selection of an initial MU-MIMO group size. The graph 200 shows an example sum capacity 220 in bits per second over Hertz (bps/Hz) for a network, such as the network 100 of FIG. 1. The sum capacity 220 is a measure of the bandwidth efficiency of the network 100 and includes the total of each of the STAs connected to an AP, such as the AP 105 of FIG. 1. A curve 210 shows the relationship between the sum capacity 220 and the MU-MIMO group size 230 for the STAs, such as the STAs 110 of FIG. 1, connected to the AP 105.

As shown, the sum capacity 220 is lower for group sizes of 1 to 4 STAs. The sum capacity 220 peaks around group size 5, represented at point 240. The sum capacity 220 remains about the same for a group size of 6, and then begins to drop off for groups of 7 and 8 STAs. For six users, each STA may be running at a lower MCS and data rate compared to the MCS and data rate for five users. The sum capacity 220 may also be affected by the initial MCS for each STA. Techniques described herein may enable the network 100 to determine an initial group size 230 and/or an initial MCS for each STA invited to join the MU-MIMO group. As described herein, an AP or a STA may perform some of, or all of, the techniques described.

APs operating to previous standards, for example, according to the 802.11ac standard, may not have degraded network capacity with larger group size because they operated in the linear part of the curve 210, between 1-4 users. In this particular example, the APs had a maximum number of three users and four spatial streams. However, APs using different standards, such as the 802.11ax (also referred to as High Efficiency Wireless), may have up to 8 users and 8 spatial streams. For example, other APs may use 4 users and 4 spatial streams.

FIG. 3 illustrates an example of a swim diagram 300 that shows an AP 105-a connected to multiple STAs 110-a, 110-b, and 110-c for MU-MIMO grouping for a large number of MU-MIMO clients. In this example, there may be N MU-MIMO clients. The AP 105-a may be an example of aspects of an AP 105 as described with reference to FIG. 1. The STAs 110-a, 110-b, and 110-c may be examples of aspects of a STA 110 as described with reference to FIG. 1. FIG. 3 illustrates up to N number of STAs, wherein N is a whole number supported by the MU-MIMO system. In one example, N may be a number between one and eight. In other examples, N may be more than eight. Although only three STAs 110 are included in FIG. 3 for illustrative purposes, more or less than three STAs may be used.

The AP 105-a may broadcast, multicast, or unicast, a CBF poll 305 to at least one of the STAs 110-a, 110-b, and 110-c. In the example of FIG. 3, the CBF poll 305 is transmitted to each of the STAs 110-a, 110-b, and 110-c. The CBF poll 305 may request CBF reports 310 from each of the STAs that receives the CBF poll 305. In response, the STAs 110-a, 110-b, and 110-c each transmit a CBF report 310 to the AP 105-a. In some examples, such as those using 802.11ac MU, only the first STA 110 can send a CBF report after the sounding sequence without a beamforming report (BR) poll frame or a CBF poll, while other STAs 110 have to wait for the BR Poll to send their CBF reports. In other examples, such as for 802.11ax MU, all STAs 110 may report their CBF reports after a trigger frame (which may be a BR poll) at the same time.

Although shown here for simplicity that the CBF reports 310 are transmitted at approximately the same time by each of the STAs 110-a, 110-b, and 110-c, they may not be. In an example according to the 802.11ac protocol, sequential CBF reception is received from each STA 110. One sounding sequence may be as follows, from the AP 105-a perspective: a null data packet announcement (NDPA) frame is received, then a null data packet (NDP) is sent, then a compressed beamforming report 1 is received, then a BR poll is sent, then a CBF report 2 is received, then another BR poll frame is sent, then a CBF report 3 is received, etc. Another sounding sequence according to the 802.11ax protocol may be as follows, from the AP 105-a perspective: NDPA frame, NDP, trigger frame, CBF reports from all users in UL OFDMA or UL MU-MIMO.

A CBF report 310 may provide feedback to the AP 105-a. The CBF report 310 may include information related to an average SNR for the STA 110, a delta SNR per subcarrier, and a compressed beamforming feedback matrix of the entire channel. In other examples, the CBF report 310 includes other or less information. In some examples, the average SNR is an average SNR per space-time stream. The STAs 110 may not have the same number of space-time streams.

From the CBF reports, the AP 105-a may identify a noise parameter at block 315. In some examples, the AP 105-a identifies the noise parameter based at least in part on an average SNR per space-time stream in the CBF report for each STA 110. In some examples, the AP 105-a may first extract the average SNR per space-time stream and if the STA 110 has more than one spatial stream, the AP 105-a may average the SNRs of those spatial streams to get a single-user (SU) SNR. If there is only a single spatial stream for the STA 110, then the AP 105-a does not perform the averaging step. The AP 105-a may extract the noise parameter from a SU SNR for a plurality of spatial streams based at least in part on the average SNR per space-time stream. In some examples, for each user, the AP 105-a may combine the SU SNRs across all its spatial streams, the user SU SNR. The user SU SNR may be based at least in part on the average SNR per space-time stream. In some examples, combining can be a log domain averaging to combine the SU SNR across multiple spatial streams. In other examples, other formulas or methods may be used to combine the SU SNR across the multiple spatial streams.

For each STA 110, if the user SU SNR is below a noise parameter threshold (e.g., 5 dB), the AP 105-a may exclude this STA from the MU-MIMO group. The AP 105-a may schedule this STA as a single user or as an orthogonal frequency division multiple access (OFDMA) STA to be scheduled with other scheduled OFDMA STAs. The noise parameter threshold may be denoted as Th₁ and Equation 1 may be used.

user SU SNR≦Th₁, then set user as SU (1)

For any remaining users (e.g., those STAs whose user SU SNR>Th₁), the AP 105-a may calculate the average SU SNR across all users, which may be denoted avg-all-SU-SNR.

In other examples, the AP 105-a may identify the noise parameter based at least in part on data from historical CBF reports. For example, the AP 105-a may use previously received CBF reports to identify the noise parameter. In some implementations, extracting the SU SNR from the CBF report and constructing the MU Physical Layer Convergence Protocol (PLCP) Protocol Data Unit (PPDU) may take more time than a short interframe space (SIFS). In these instances, the AP 105-a may use data from historical SU SNR extracted from previous CBFs.

For group size selection based on historic SU SNR from the CBF, the AP 105-a may extract the SU SNR for each STA for each stream for each sounding sequence. The AP 105-a may combine the SU SNR across all streams to get SU SNR per user if there is more than one spatial stream for the users. The average SU SNR with the corresponding historic SU SNR data may be as follows in Equation 2, wherein CBF SU SNR is a new sample of SU SNR for user i.

SU−SNRᵢ=α(CBF−SU−SNRᵢ)+(1−α)SU−SNRᵢ (2)

Regardless of how the SU SNR is determined, the AP 105-a may determine an initial MU-MIMO group size and/or an initial MCS from the noise parameter at blocks 320 and 325. These determinations may be based on an SU SNR from the CBF reports 310. In one example, the AP 105-a may determine an initial group size (Ms) and a corresponding initial MCS for a first Physical Layer Convergence Protocol (PLCP) Protocol Data Unit (PPDU) in a PPDU burst based on the avg-all-SU-SNR. In some examples, the AP 105-a may consult a table to determine the initial Ms and initial MCS for the first PPDU. An example table is provided in Table 1.

TABLE 1

| | Initial Group | |
|---|---|---|
| avg-all-SU-SNR | Size (Ms) | Initial MCS |
| Th₁ < avg-all-SU-SNR ≦ Th₂ | 4 | init_MCS₄ |
| Th₂ < avg-all-SU-SNR ≦ Th₃ | 5 | init_MCS₅ |
| Th₃ < avg-all-SU-SNR ≦ Th₄ | 6 | init_MCS₆ |
| Th₄ < avg-all-SU-SNR | 7 | init_MCS₇ |

The thresholds Th₁ through Th₄ may be selected, which may be at least in part based on empirical data. One example set of thresholds may include Th₁=5 dB, Th₂=10 dB, Th₃=20 dB, and Th₄=30 dB. This is just one example, and many other values and combinations of thresholds may be used in other examples. Similarly, the initial MCS may be selected and may be based at least in part on empirical data. Example initial MCS values may include init_MCS₄=6, init_MCS₅=6, init_MCS₆=5, and init_MCS₇=5. This is just one example, and many other values and combinations of initial MCS values may be used in other examples.

After determining the initial group size (Ms), the AP 105-a selects which users will be scheduled for the first PPDU after sounding. Based on these determinations, the AP 105-a may select which STAs to schedule for a first PPDU at block 330. In some examples, the STAs with a largest metric among the set of STAs with the largest scheduler priority may be selected. The metric may be a function of a STA's queue depth, the STA's MCS, and media access control (MAC) overhead for an MU group of size Ms. In some examples, the scheduler priority may be a function of quality of service (QoS) of the traffic for each user and large scale fairness among users. In some examples, the AP 105-a may choose the MCS and/or the number of spatial streams (Nss) based on a packet error rate (PER) based rate adaptation recommendation for the chosen group size. The PER may be tracked as a function of Nss and Nss_tot (the total number of spatial streams in the MU group). That is, the PER may be tracked independently for each group.

In the example of FIG. 3, the AP 105-a selects STAs 110-a and 110-c for scheduling for the first PPDU. The AP 105-a may not have chosen the STA 110-b because its user SU SNR may have been below the first noise threshold. The AP 105-a sends a DL MU PPDU 335 to the STAs 110-a and 110-c. This is an example of DL MU-MIMO communications. The STAs 110-a and 110-c respond to the DL MU PPDU 335 with acknowledgements (ACK) 340.

Additionally, techniques described herein may update group size and MCS for subsequent PPDUs. In one example, the MU-MIMO group size can be adapted through group size probing (e.g., transmitting a PPDU at a larger group size than the previously used group size). For example, the AP 105-a may increase the MU-MIMO group size by one. If the PER for the probed group size is below a threshold PER, the STAs may continue transmitting on this group size. Otherwise, the AP 105-a may revert the MU-MIMO group size back to the previous group size. The AP 105-a may update the MCS of subsequent PPDUs based on the PER of the first PPDU using intra-sounding rate adaption. This may indirectly take the impact of channel type and channel variation into account in adapting the MU group size and MCS.

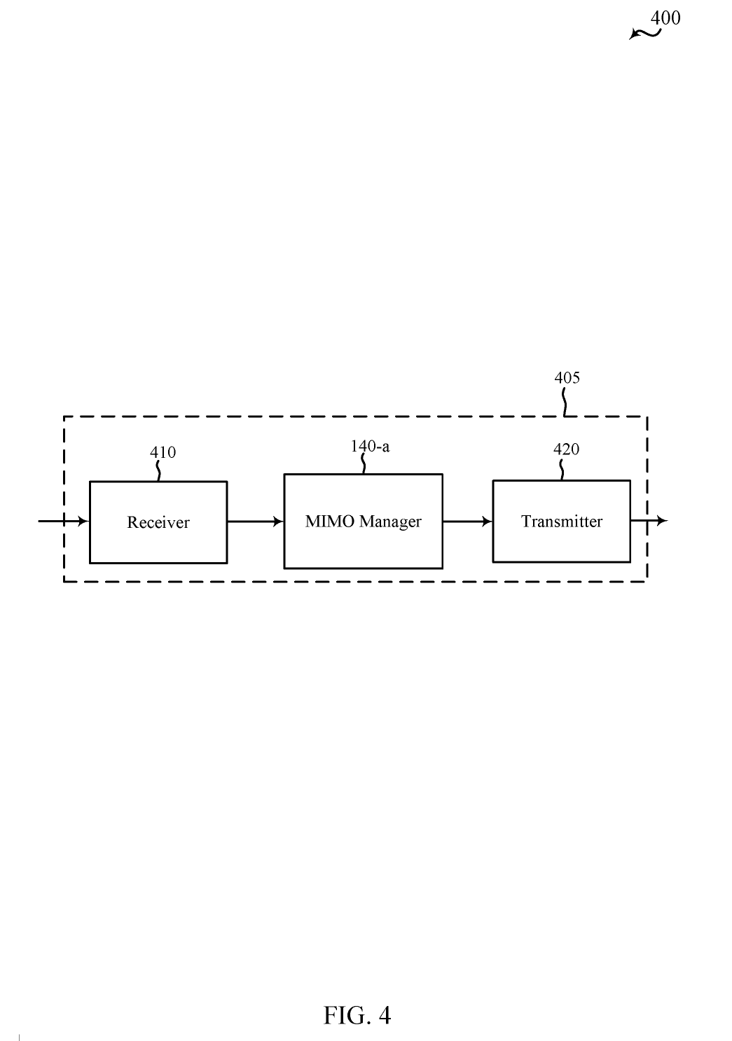

FIG. 4 shows a block diagram 400 of a wireless device 405 that supports MU-MIMO grouping for a large number of MU-MIMO clients in accordance with various aspects of the present disclosure. Wireless device 405 may be an example of aspects of a STA 110 or AP 105 as described with reference to FIG. 1. Wireless device 405 may include receiver 410, MIMO manager 140-a, and transmitter 420. Wireless device 405 may also include a processor. Each of these components may be in communication with one another (e.g., via one or more buses).

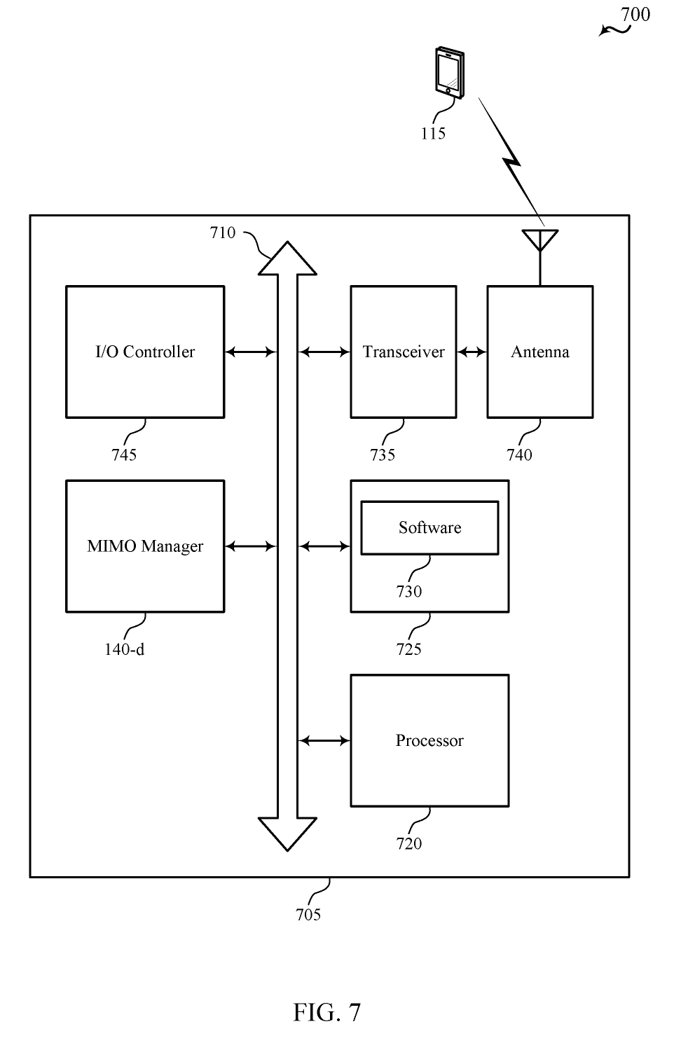

The receiver 410 may receive information such as packets, user data, or control information associated with various information channels (e.g., control channels, data channels, and information related to MU-MIMO grouping for a large number of MU-MIMO clients, etc.). Information may be passed on to other components of the device. The receiver 410 may be an example of aspects of the transceiver 735 described with reference to FIG. 7.

The MIMO manager 140-a may be an example of aspects of the MIMO manager 140 described with reference to FIGS. 1 and 5-7. The MIMO manager 140-a may identify, from a CBF report, a noise parameter for communications with a UE and determine at least one of an initial MU-MIMO group size and an initial MCS based on the noise parameter.

The transmitter 420 may transmit signals generated by other components of the device. In some examples, the transmitter 420 may be collocated with a receiver 410 in a transceiver module. For example, the transmitter 420 may be an example of aspects of the transceiver 735 described with reference to FIG. 7. The transmitter 420 may include a single antenna, or it may include a set of antennas. For example, the transmitter 420 may transmit data based on at least one of the initial MU-MIMO group size and the initial MCS, transmit subsequent data based on the adjusted MU-MIMO group size, and transmit subsequent data based on the adjusted MCS.

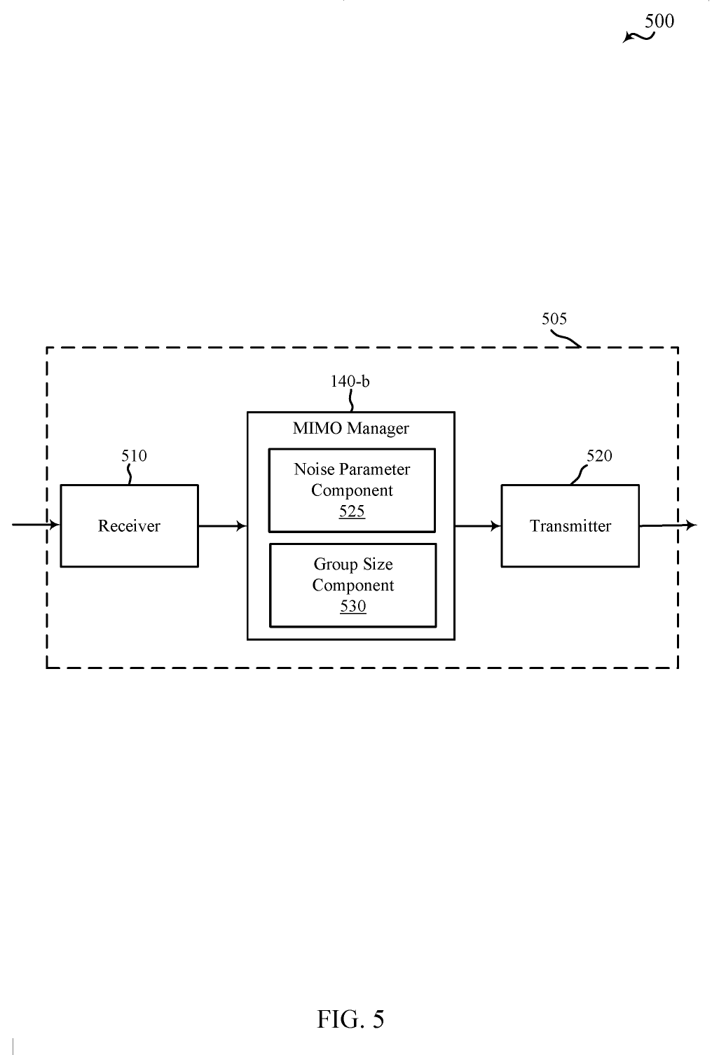

FIG. 5 shows a block diagram 500 of a wireless device 505 that supports MU-MIMO grouping for a large number of MU-MIMO clients in accordance with various aspects of the present disclosure. Wireless device 505 may be an example of aspects of a wireless device 405 or a STA 110 or AP 105 as described with reference to FIGS. 1, 3, and 4. Wireless device 505 may include receiver 510, MIMO manager 140-b, and transmitter 520. Wireless device 505 may also include a processor. Each of these components may be in communication with one another (e.g., via one or more buses).

The receiver 510 may receive information such as packets, user data, or control information associated with various information channels (e.g., control channels, data channels, and information related to MU-MIMO grouping for a large number of MU-MIMO clients, etc.). Information may be passed on to other components of the device. The receiver 510 may be an example of aspects of the transceiver 735 described with reference to FIG. 7.

The MIMO manager 140-b may be an example of aspects of the MIMO manager 140 described with reference to FIGS. 1, 4, 6, and 7. The MIMO manager 140-b may also include a noise parameter component 525 and a group size component 530.

The noise parameter component 525 may identify, from a CBF report, a noise parameter for communications with a UE. In some cases, identifying the noise parameter further includes identifying the noise parameter based on an average SNR per space-time stream in the CBF report. In some cases, identifying the noise parameter further includes identifying the noise parameter from a SU SNR for a set of spatial streams based on the average SNR per space-time stream. In some cases, identifying the noise parameter from a SU SNR further includes combining SU SNRs across all spatial streams for the UE based on the average SNR per space-time stream. In some cases, identifying the noise parameter further includes identifying the noise parameter based on data from historical CBF reports.

The MU-MIMO group size component 530 may determine at least one of an initial MU-MIMO group size and an initial MCS based on the noise parameter and determine an adjusted MU-MIMO group size based on a PER. In some cases, determining at least one of an initial MU-MIMO group size and an initial MCS based on the noise parameter further includes determining the initial MU-MIMO group size based on the noise parameter and determining the initial MCS based on the MU-MIMO group size. In some cases, determining at least one of the initial MU-MIMO group size and the initial MCS further includes determining an average noise parameter for all UEs included in the CBF report and consulting a table to determine the at least one of the initial MU-MIMO group size and the initial MCS based on the average noise parameter.

The transmitter 520 may transmit signals generated by other components of the device. In some examples, the transmitter 520 may be collocated with a receiver 510 in a transceiver module. For example, the transmitter 520 may be an example of aspects of the transceiver 735 described with reference to FIG. 7. The transmitter 520 may include a single antenna, or it may include a set of antennas.

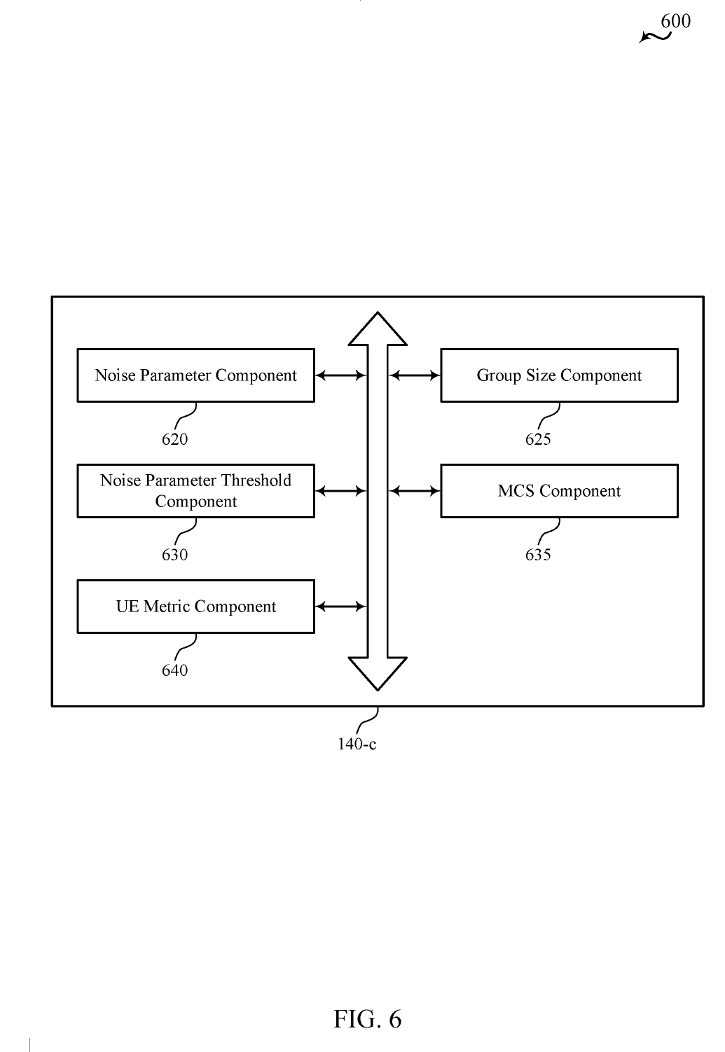

FIG. 6 shows a block diagram 600 of a MIMO manager 140-c that supports MU-MIMO grouping for a large number of MU-MIMO clients in accordance with various aspects of the present disclosure. The MIMO manager 140-c may be an example of aspects of a MIMO manager 140 described with reference to FIGS. 1, 4, 5, and 7. The MIMO manager 140-c may include a noise parameter component 620, a group size component 625, a noise parameter threshold component 630, a MCS component 635, and a UE metric component 640. Each of these modules may communicate, directly or indirectly, with one another (e.g., via one or more buses).

The noise parameter component 620 may identify, from a CBF report, a noise parameter for communications with a UE. The MU-MIMO group size component 625 may determine at least one of an initial MU-MIMO group size and an initial MCS based on the noise parameter and determine an adjusted MU-MIMO group size based on a PER.

The noise parameter threshold component 630 may compare a noise parameter to a threshold. In some cases, determining at least one of the initial MU-MIMO group size and the initial MCS further includes determining that the noise parameter exceeds a first noise parameter threshold and including the UE in a multi-user group. In some cases, determining at least one of the initial MU-MIMO group size and the initial MCS further includes determining that the noise parameter does not exceed a first noise parameter threshold and excluding the UE from a multi-user group.

The MCS component 635 may determine an adjusted MCS based on a PER. The UE metric component 640 may determine a metric for each UE included in the CBF report and select which UEs to schedule for a first PPDU based on the initial MU-MIMO group size and the metric. In some examples, the metric may be related to a transmitter scheduler score.

FIG. 7 shows a diagram of a system 700 including a device 705 that supports MU-MIMO grouping for a large number of MU-MIMO clients in accordance with various aspects of the present disclosure. The device 705 may be an example of or include the components of wireless device 405, wireless device 505, or a STA 110 or AP 105 as described above, e.g., with reference to FIGS. 1, 4 and 5. The device 705 may include components for bi-directional voice and data communications including components for transmitting and receiving communications, including the MIMO manager 140-d, a processor 720, a memory 725, software 730, a transceiver 735, an antenna 740, and an I/O controller 745. These components may be in electronic communication via one or more busses (e.g., bus 710).

The processor 720 may include an intelligent hardware device, (e.g., a general-purpose processor, a digital signal processor (DSP), a central processing unit (CPU), a microcontroller, an application-specific integrated circuit (ASIC), an field-programmable gate array (FPGA), a programmable logic device, a discrete gate or transistor logic component, a discrete hardware component, or any combination thereof). In some cases, the processor 720 may be configured to operate a memory array using a memory controller. In other cases, a memory controller may be integrated into the processor 720. The processor 720 may be configured to execute computer-readable instructions stored in a memory to perform various functions (e.g., functions or tasks supporting MU-MIMO grouping for a large number of MU-MIMO clients).

The memory 725 may include random access memory (RAM) and read only memory (ROM). The memory 725 may store computer-readable, computer-executable software 730 including instructions that, when executed, cause the processor to perform various functions described herein. In some cases, the memory 725 may contain, among other things, a basic input/output system (BIOS) which may control basic hardware and/or software operation such as the interaction with peripheral components or devices.

The software 730 may include code to implement aspects of the present disclosure, including code to support MU-MIMO grouping for a large number of MU-MIMO clients. The software 730 may be stored in a non-transitory computer-readable medium such as system memory or other memory. In some cases, the software 730 may not be directly executable by the processor but may cause a computer (e.g., when compiled and executed) to perform functions described herein.

The transceiver 735 may communicate bi-directionally, via one or more antennas, wired, or wireless links as described above. For example, the transceiver 735 may represent a wireless transceiver and may communicate bi-directionally with another wireless transceiver. The transceiver 735 may also include a modem to modulate the packets and provide the modulated packets to the antennas for transmission, and to demodulate packets received from the antennas.

In some cases, the wireless device may include a single antenna 740. However, in some cases the device may have more than one antenna 740, which may be capable of concurrently transmitting or receiving multiple wireless transmissions.

The I/O controller 745 may manage input and output signals for device 705. The I/O controller 745 may also manage peripherals not integrated into device 705. In some cases, the I/O controller 745 may represent a physical connection or port to an external peripheral. In some cases, the I/O controller 745 may utilize an operating system such as iOS®, ANDROID®, MS-DOS®, MS-WINDOWS®, OS/2®, UNIX®, LINUX®, or another known operating system.

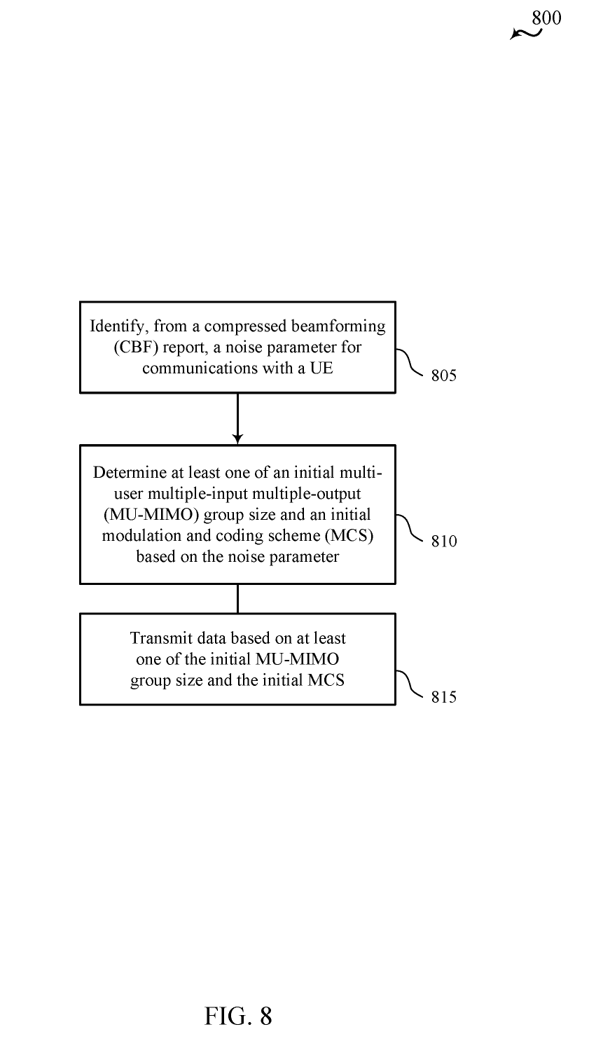

FIG. 8 shows a flowchart illustrating a method 800 for MU-MIMO grouping for a large number of MU-MIMO clients in accordance with various aspects of the present disclosure. The operations of the method 800 may be implemented by a STA 110 or AP 105 or its components as described herein. For example, the operations of the method 800 may be performed by a MIMO manager 140 as described with reference to FIGS. 1 and 4 through 7. In some examples, a STA 110 or AP 105 may execute a set of codes to control the functional elements of the device to perform the functions described below. Additionally or alternatively, the STA 110 or AP 105 may perform aspects the functions described below using special-purpose hardware.

At block 805, the STA 110 or AP 105 may identify, from a CBF report, a noise parameter for communications with a UE. The operations of block 805 may be performed according to the methods described with reference to FIGS. 1 through 3. In certain examples, aspects of the operations of block 805 may be performed by a noise parameter component as described with reference to FIGS. 4 through 7.

At block 810, the STA 110 or AP 105 may determine at least one of an initial MU-MIMO group size and an initial MCS based at least in part on the noise parameter. The operations of block 810 may be performed according to the methods described with reference to FIGS. 1 through 3. In certain examples, aspects of the operations of block 810 may be performed by a group size component as described with reference to FIGS. 4 through 7.

At block 815, the STA 110 or AP 105 may transmit data based on at least one of the initial MU-MIMO group size and the initial MCS. The operations of block 815 may be performed according to the methods described with reference to FIGS. 1 through 3. In certain examples, aspects of the operations of block 815 may be performed by a transmitter as described with reference to FIGS. 4 through 7.

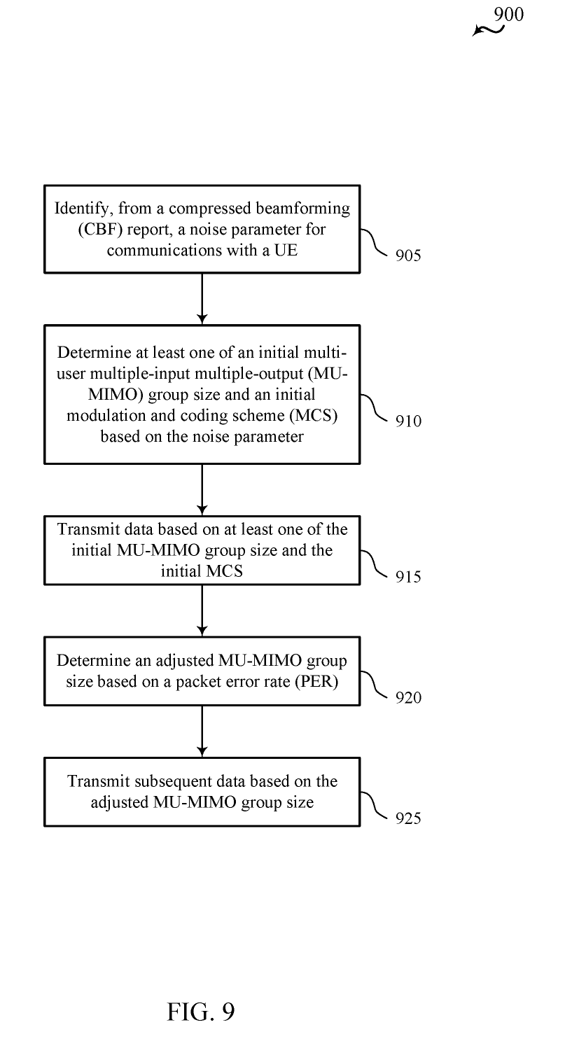

FIG. 9 shows a flowchart illustrating a method 900 for MU-MIMO grouping for a large number of MU-MIMO clients in accordance with various aspects of the present disclosure. The operations of method 900 may be implemented by a STA 110 or AP 105 or its components as described herein. For example, the operations of method 900 may be performed by a MIMO manager 140 as described with reference to FIGS. 1 and 4 through 7. In some examples, a STA 110 or AP 105 may execute a set of codes to control the functional elements of the device to perform the functions described below. Additionally or alternatively, the STA 110 or AP 105 may perform aspects the functions described below using special-purpose hardware.

At block 905, the STA 110 or AP 105 may identify, from a CBF report, a noise parameter for communications with a UE. The operations of block 905 may be performed according to the methods described with reference to FIGS. 1 through 3. In certain examples, aspects of the operations of block 905 may be performed by a noise parameter component as described with reference to FIGS. 4 through 7.

At block 910, the STA 110 or AP 105 may determine at least one of an initial MU-MIMO group size and an initial MCS based at least in part on the noise parameter. The operations of block 910 may be performed according to the methods described with reference to FIGS. 1 through 3. In certain examples, aspects of the operations of block 910 may be performed by a group size component as described with reference to FIGS. 4 through 7.

At block 915, the STA 110 or AP 105 may transmit data based on at least one of the initial MU-MIMO group size and the initial MCS. The operations of block 915 may be performed according to the methods described with reference to FIGS. 1 through 3. In certain examples, aspects of the operations of block 915 may be performed by a transmitter as described with reference to FIGS. 4 through 7.

At block 920, the STA 110 or AP 105 may determine an adjusted MU-MIMO group size based at least in part on a PER. The operations of block 920 may be performed according to the methods described with reference to FIGS. 1 through 3. In certain examples, aspects of the operations of block 920 may be performed by a group size component as described with reference to FIGS. 4 through 7.

At block 925, the STA 110 or AP 105 may transmit subsequent data based on the adjusted MU-MIMO group size. The operations of block 925 may be performed according to the methods described with reference to FIGS. 1 through 3. In certain examples, aspects of the operations of block 925 may be performed by a transmitter as described with reference to FIGS. 4 through 7.

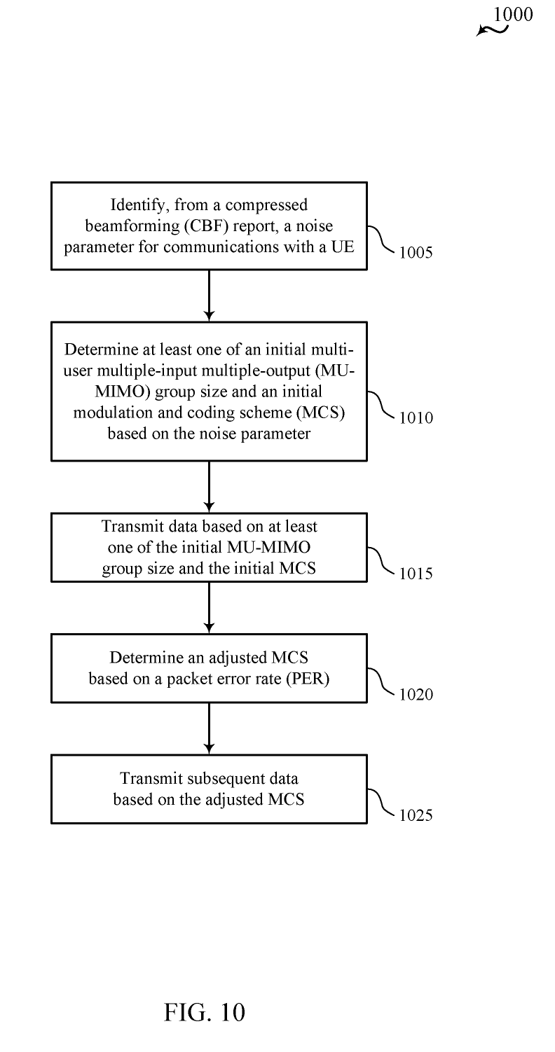

FIG. 10 shows a flowchart illustrating a method 1000 for MU-MIMO grouping for a large number of MU-MIMO clients in accordance with various aspects of the present disclosure. The operations of method 1000 may be implemented by a STA 110 or AP 105 or its components as described herein. For example, the operations of method 1000 may be performed by a MIMO manager 140 as described with reference to FIGS. 1 and 4 through 7. In some examples, a STA 110 or AP 105 may execute a set of codes to control the functional elements of the device to perform the functions described below. Additionally or alternatively, the STA 110 or AP 105 may perform aspects the functions described below using special-purpose hardware.

At block 1005 the STA 110 or AP 105 may identify, from a CBF report, a noise parameter for communications with a UE. The operations of block 1005 may be performed according to the methods described with reference to FIGS. 1 through 3. In certain examples, aspects of the operations of block 1005 may be performed by a noise parameter component as described with reference to FIGS. 4 through 7.

At block 1010 the STA 110 or AP 105 may determine at least one of an initial MU-MIMO group size and an initial MCS based at least in part on the noise parameter. The operations of block 1010 may be performed according to the methods described with reference to FIGS. 1 through 3. In certain examples, aspects of the operations of block 1010 may be performed by a group size component as described with reference to FIGS. 4 through 7.

At block 1015 the STA 110 or AP 105 may transmit data based on at least one of the initial MU-MIMO group size and the initial MCS. The operations of block 1015 may be performed according to the methods described with reference to FIGS. 1 through 3. In certain examples, aspects of the operations of block 1015 may be performed by a transmitter as described with reference to FIGS. 4 through 7.

At block 1020 the STA 110 or AP 105 may determine an adjusted MCS based at least in part on a PER. The operations of block 1020 may be performed according to the methods described with reference to FIGS. 1 through 3. In certain examples, aspects of the operations of block 1020 may be performed by a MCS component as described with reference to FIGS. 4 through 7.

At block 1025 the STA 110 or AP 105 may transmit subsequent data based on the adjusted MCS. The operations of block 1025 may be performed according to the methods described with reference to FIGS. 1 through 3. In certain examples, aspects of the operations of block 1025 may be performed by a transmitter as described with reference to FIGS. 4 through 7.

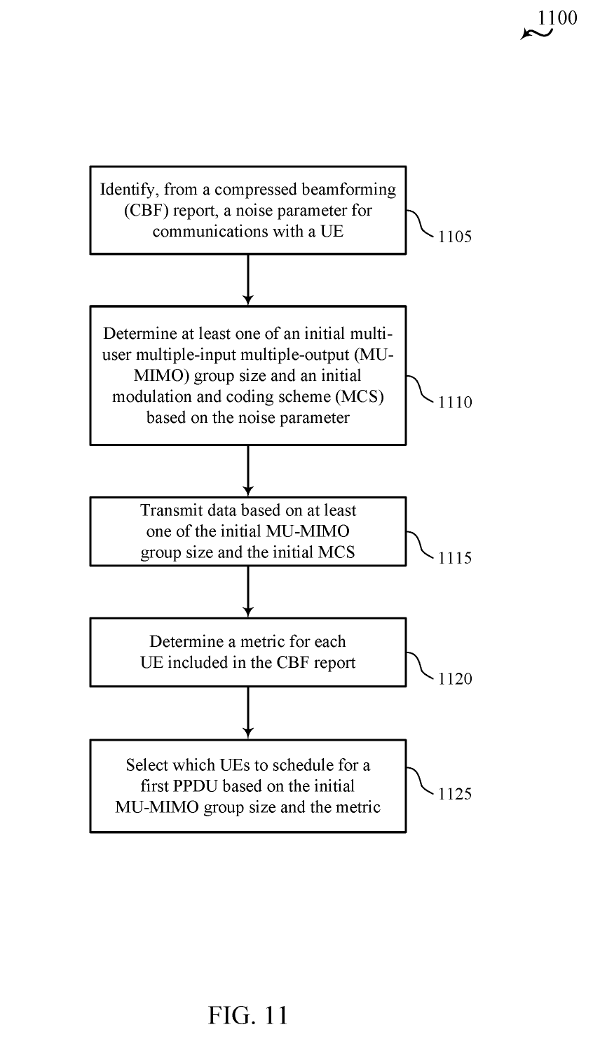

FIG. 11 shows a flowchart illustrating a method 1100 for MU-MIMO grouping for a large number of MU-MIMO clients in accordance with various aspects of the present disclosure. The operations of method 1100 may be implemented by a STA 110 or AP 105 or its components as described herein. For example, the operations of method 1100 may be performed by a MIMO manager 140 as described with reference to FIGS. 1 and 4 through 7. In some examples, a STA 110 or AP 105 may execute a set of codes to control the functional elements of the device to perform the functions described below. Additionally or alternatively, the STA 110 or AP 105 may perform aspects the functions described below using special-purpose hardware.

At block 1105 the STA 110 or AP 105 may identify, from a CBF report, a noise parameter for communications with a UE. The operations of block 1105 may be performed according to the methods described with reference to FIGS. 1 through 3. In certain examples, aspects of the operations of block 1105 may be performed by a noise parameter component as described with reference to FIGS. 4 through 7.

At block 1110 the STA 110 or AP 105 may determine at least one of an initial MU-MIMO group size and an initial MCS based at least in part on the noise parameter. The operations of block 1110 may be performed according to the methods described with reference to FIGS. 1 through 3. In certain examples, aspects of the operations of block 1110 may be performed by a group size component as described with reference to FIGS. 4 through 7.

At block 1115 the STA 110 or AP 105 may transmit data based on at least one of the initial MU-MIMO group size and the initial MCS. The operations of block 1115 may be performed according to the methods described with reference to FIGS. 1 through 3. In certain examples, aspects of the operations of block 1115 may be performed by a transmitter as described with reference to FIGS. 4 through 7.

At block 1120 the STA 110 or AP 105 may determine a metric for each UE included in the CBF report. The operations of block 1120 may be performed according to the methods described with reference to FIGS. 1 through 3. In certain examples, aspects of the operations of block 1120 may be performed by a UE metric component as described with reference to FIGS. 4 through 7.

At block 1125 the STA 110 or AP 105 may select which UEs to schedule for a first Physical Layer Convergence Protocol (PLCP) Protocol Data Unit (PPDU) based at least in part on the initial MU-MIMO group size and the metric. The operations of block 1125 may be performed according to the methods described with reference to FIGS. 1 through 3. In certain examples, aspects of the operations of block 1125 may be performed by a UE metric component as described with reference to FIGS. 4 through 7.

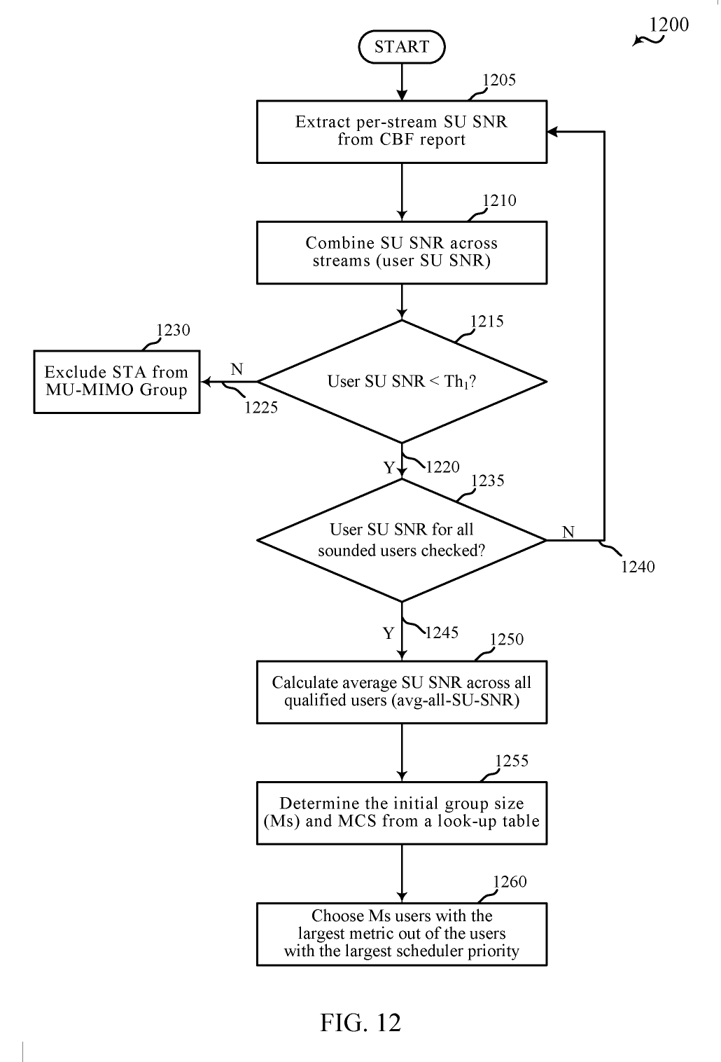

FIG. 12 shows a flowchart illustrating a method 1200 for MU-MIMO grouping for a large number of MU-MIMO clients in accordance with various aspects of the present disclosure. The operations of the method 1200 may be implemented by a STA 110 or AP 105 or its components as described herein. For example, the operations of the method 1200 may be performed by a MIMO manager 140 as described with reference to FIGS. 1 and 4 through 7. In some examples, a STA 110 or AP 105 may execute a set of codes to control the functional elements of the device to perform the functions described below. Additionally or alternatively, the STA 110 or AP 105 may perform aspects the functions described below using special-purpose hardware.

The method 1200 begins at block 1205 with extracting a per-stream SU SNR from a CBF report for a STA connected to an AP. The method 1200 includes combining the SU SNR across all spatial streams for the STA to determine the user SU SNR at block 1210. At block 1215, the method 1200 determines whether the user SU SNR is below a threshold Th₁. If it is, the method 1200 follows path 1225 to block 1230 and the STA is excluded from the MU-MIMO group. If not, the method 1200 proceeds along path 1220 to block 1235.

At block 1235, the method 1200 determines whether the user SU SNR for all sounded users were checked. If not, the method 1200 follows path 1240 back to block 1205 and repeats the above described steps. If so, the method 1200 follows path 1245 to block 1250. At block 1250, the method 1200 includes calculating an average SU SNR across all of the qualified users. The method 1200 may determine the initial MU-MIMO group size (Ms) and MCS from a look-up table at block 1255. The method 1200 may also include choosing the MU-MIMO group users with the largest metric out of the users having the largest schedule priority to schedule the user for the next PPDU at block 1260.

It should be noted that the methods described above describe possible implementations, and that the operations and the steps may be rearranged or otherwise modified and that other implementations are possible. Furthermore, aspects from two or more of the methods may be combined.

Techniques described herein may be used for various wireless communications systems such as code division multiple access (CDMA), time division multiple access (TDMA), frequency division multiple access (FDMA), orthogonal frequency division multiple access (OFDMA), single carrier frequency division multiple access (SC-FDMA), and other systems. The terms “system” and “network” are often used interchangeably. A code division multiple access (CDMA) system may implement a radio technology such as CDMA2000, Universal Terrestrial Radio Access (UTRA), etc. CDMA2000 covers IS-2000, IS-95, and IS-856 standards. IS-2000 Releases may be commonly referred to as CDMA2000 1×, 1×, etc. IS-856 (TIA-856) is commonly referred to as CDMA2000 1×EV-DO, High Rate Packet Data (HRPD), etc. UTRA includes Wideband CDMA (WCDMA) and other variants of CDMA. A time division multiple access (TDMA) system may implement a radio technology such as Global System for Mobile Communications (GSM). An orthogonal frequency division multiple access (OFDMA) system may implement a radio technology such as Ultra Mobile Broadband (UMB), Evolved UTRA (E-UTRA), IEEE 802.11 (Wi-Fi), IEEE 802.16 (WiMAX), IEEE 802.20, Flash-OFDM, etc.

The wireless communications system or systems described herein may support synchronous or asynchronous operation. For synchronous operation, the stations may have similar frame timing, and transmissions from different stations may be approximately aligned in time. For asynchronous operation, the stations may have different frame timing, and transmissions from different stations may not be aligned in time. The techniques described herein may be used for either synchronous or asynchronous operations.

The downlink transmissions described herein may also be called forward link transmissions while the uplink transmissions may also be called reverse link transmissions. Each communication link described herein—including, for example, wireless communications system 100 of FIG. 1—may include one or more carriers, where each carrier may be a signal made up of multiple sub-carriers (e.g., waveform signals of different frequencies).

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

Information and signals described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above may be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, electrically erasable programmable read only memory (EEPROM), compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, digital subscriber line (DSL), or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

What is claimed is:

1. A method for wireless communication, comprising:
identifying, from a compressed beamforming (CBF) report, a noise parameter for communications with a user equipment (UE);
determining at least one of an initial multi-user multiple-input multiple-output (MU-MIMO) group size and an initial modulation and coding scheme (MCS) based at least in part on the noise parameter; and
transmitting data based on at least one of the initial MU-MIMO group size and the initial MCS.

2. The method of claim 1, wherein identifying the noise parameter further comprises:
identifying the noise parameter based at least in part on an average signal-to-noise ratio (SNR) per space-time stream in the CBF report.

3. The method of claim 2, wherein identifying the noise parameter further comprises:
identifying the noise parameter from a single user (SU) SNR for a plurality of spatial streams based at least in part on the average SNR per space-time stream.

4. The method of claim 2, wherein identifying the noise parameter from a SU SNR further comprises:
combining SU SNRs across all spatial streams for the UE based at least in part on the average SNR per space-time stream.

5. The method of claim 1, wherein identifying the noise parameter further comprises:
identifying the noise parameter based at least in part on data from historical CBF reports.

6. The method of claim 1, wherein determining at least one of the initial MU-MIMO group size and the initial MCS further comprises:
determining that the noise parameter exceeds a first noise parameter threshold; and
including the UE in a multi-user group.

7. The method of claim 1, wherein determining at least one of the initial MU-MIMO group size and the initial MCS further comprises:
determining that the noise parameter does not exceed a first noise parameter threshold; and
excluding the UE from a multi-user group.

8. The method of claim 1, further comprising:
determining an adjusted MU-MIMO group size based at least in part on a packet error rate (PER); and
transmitting subsequent data based on the adjusted MU-MIMO group size.

9. The method of claim 1, further comprising:
determining an adjusted MCS based at least in part on a packet error rate (PER); and
transmitting subsequent data based on the adjusted MCS.

10. The method of claim 1, wherein determining at least one of an initial MU-MIMO group size and an initial MCS based at least in part on the noise parameter further comprises:
determining the initial MU-MIMO group size based at least in part on the noise parameter and determining the initial MCS based on the MU-MIMO group size.

11. The method of claim 1, wherein determining at least one of the initial MU-MIMO group size and the initial MCS further comprises:
determining an average noise parameter for all UEs included in the CBF report and consulting a table to determine the at least one of the initial MU-MIMO group size and the initial MCS based at least in part on the average noise parameter.

12. The method of claim 1, further comprising:
determining a metric for each UE included in the CBF report; and
selecting which UEs to schedule for a first Physical Layer Convergence Protocol (PLCP) Protocol Data Unit (PPDU) based at least in part on the initial MU-MIMO group size and the metric.

13. An apparatus for wireless communication, in a system comprising:
a processor;
memory in electronic communication with the processor; and
instructions stored in the memory and operable, when executed by the processor, to cause the apparatus to:
identify, from a compressed beamforming (CBF) report, a noise parameter for communications with a user equipment (UE);
determine at least one of an initial multi-user multiple-input multiple-output (MU-MIMO) group size and an initial modulation and coding scheme (MCS) based at least in part on the noise parameter; and
transmit data based on at least one of the initial MU-MIMO group size and the initial MCS.

14. The apparatus of claim 13, wherein the instructions to identify the noise parameter are further executable by the processor to:
identify the noise parameter based at least in part on an average signal-to-noise ratio (SNR) per space-time stream in the CBF report.

15. The apparatus of claim 14, wherein the instructions to identify the noise parameter are further executable by the processor to:
identify the noise parameter from a single user (SU) SNR for a plurality of spatial streams based at least in part on the average SNR per space-time stream.

16. The apparatus of claim 14, wherein the instructions to identify the noise parameter are further executable by the processor to:
combine SU SNRs across all spatial streams for the UE based at least in part on the average SNR per space-time stream.

17. The apparatus of claim 13, wherein the instructions to identify the noise parameter are further executable by the processor to:
identify the noise parameter based at least in part on data from historical CBF reports.

18. The apparatus of claim 13, wherein the instructions to determine at least one of the initial MU-MIMO group size and the initial MCS are further executable by the processor to:
determine that the noise parameter exceeds a first noise parameter threshold; and
include the UE in a multi-user group.

19. The apparatus of claim 13, wherein the instructions to determine at least one of the initial MU-MIMO group size and the initial MCS are further executable by the processor to:
determine that the noise parameter does not exceed a first noise parameter threshold; and
exclude the UE from a multi-user group.

20. The apparatus of claim 13, wherein the instructions are further executable by the processor to:
determine an adjusted MU-MIMO group size based at least in part on a packet error rate (PER); and
transmit subsequent data based on the adjusted MU-MIMO group size.

21. The apparatus of claim 13, wherein the instructions are further executable by the processor to:
determine an adjusted MCS based at least in part on a packet error rate (PER); and
transmit subsequent data based on the adjusted MCS.

22. The apparatus of claim 13, wherein the instructions to determine at least one of an initial MU-MIMO group size and an initial MCS based at least in part on the noise parameter are further executable by the processor to:
determine the initial MU-MIMO group size based at least in part on the noise parameter; and
determine the initial MCS based on the MU-MIMO group size.

23. The apparatus of claim 13, wherein the instructions to determine at least one of the initial MU-MIMO group size and the initial MCS are further executable by the processor to:
determine an average noise parameter for all UEs included in the CBF report; and
consult a table to determine the at least one of the initial MU-MIMO group size and the initial MCS based at least in part on the average noise parameter.

24. The apparatus of claim 13, wherein the instructions are further executable by the processor to:
determine a metric for each UE included in the CBF report; and
select which UEs to schedule for a first Physical Layer Convergence Protocol (PLCP) Protocol Data Unit (PPDU) based at least in part on the initial MU-MIMO group size and the metric.

25. An apparatus for wireless communication, comprising:
means for identifying, from a compressed beamforming (CBF) report, a noise parameter for communications with a user equipment (UE);
means for determining at least one of an initial multi-user multiple-input multiple-output (MU-MIMO) group size and an initial modulation and coding scheme (MCS) based at least in part on the noise parameter; and
means for transmitting data based on at least one of the initial MU-MIMO group size and the initial MCS.

26. The apparatus of claim 25, wherein the means for identifying the noise parameter further comprises:
means for identifying the noise parameter based at least in part on an average signal-to-noise ratio (SNR) per space-time stream in the CBF report.

27. The apparatus of claim 26, wherein the means for identifying the noise parameter further comprises:
means for identifying the noise parameter from a single user (SU) SNR for a plurality of spatial streams based at least in part on the average SNR per space-time stream.

28. The apparatus of claim 26, wherein the means for identifying the noise parameter from a SU SNR further comprises:
means for combining SU SNRs across all spatial streams for the UE based at least in part on the average SNR per space-time stream.

29. A non-transitory computer readable medium storing code for wireless communication, the code comprising instructions executable by a processor to:
identify, from a compressed beamforming (CBF) report, a noise parameter for communications with a user equipment (UE);
determine at least one of an initial multi-user multiple-input multiple-output (MU-MIMO) group size and an initial modulation and coding scheme (MCS) based at least in part on the noise parameter; and
transmit data based on at least one of the initial MU-MIMO group size and the initial MCS.

30. The non-transitory computer-readable medium of claim 29, wherein the instructions to identify the noise parameter are further executable by the processor to:
identify the noise parameter based at least in part on an average signal-to-noise ratio (SNR) per space-time stream in the CBF report.
